(19) United States
(12) Patent Application Publication
(10) Pub. No.: US 2010/0142586 A1
(43) Pub. Date: Jun. 10, 2010

(54) ELECTRONIC THERMOMETER WITH AUTOMATIC SWITCH

(76) Inventor: Chih-Chen JUAN, Taichung County (TW)

Correspondence Address: BROWDY AND NEIMARK, P.L.L.C.;624 NINTH STREET, NW, SUITE 300, WASHINGTON, DC, 20001-5303, US

(21) Appl. No.: 12/349,822

(22) Filed: Jan. 7, 2009

(30) Foreign Application Priority Data
Dec. 9, 2008 (TW) 97222097

(51) Int. Cl. G01K 1/00

(52) U.S. Cl. 374/152; 374/E01.001

(57) ABSTRACT

An electronic thermometer includes a housing having a display, a power, and a processor, wherein the display and the power are electrically connected to the processor; a sensing member having an end extended out of the housing, wherein the sensing member is electrically connected to the processor; and an automatic switch having two electrodes extended out of the housing and separated from each other, wherein the electrodes are electrically connected to the processor respectively. The automatic switch is normally turned off because the electrodes are not conducted, and the automatic switch is turned on automatic when the electrodes touch water to cause the electrodes conducted.

### BACKGROUND OF THE INVENTION

1. Field of the Invention

The present invention relates generally to a thermometer, and more particularly to an electronic thermometer with an automatic switch.

2. Description of the Related Art

Typically, mercury-in-glass thermometer is a common thermometer to sense temperature. Cheap and convenient are the advantages of the mercury-in-glass thermometer. On the contrary, easy to break, hard to read temperature are the disadvantages thereof.

Electronic thermometer is a new thermometer replacing the mercury-in-glass thermometer. Typically, the electronic thermometer is very small, and show temperature by numerals that there are fewer and fewer people use mercury-in-glass thermometer.

The electronic thermometer, however, still has some disadvantages. The most common argument of the electronic thermometer is battery. User always finds the power is out when he/she operates the electronic thermometer for sensing temperature.

Usually, the conventional electronic thermometer has a power-saving mode, which user has to press a button to turn on the power, and the power will be turned off automatically when the thermometer is not operated for minutes (usually is 1˜3 minutes). This is the most common situation that the electronic thermometer is turned on to sense temperature in 10 seconds, and then the thermometer is put there waiting for automatic turn-off. It wastes a lot unnecessary power.

### SUMMARY OF THE INVENTION

The primary objective of the present invention is to provide an electronic thermometer, which is turned on automatic when it is measuring temperature, and is turned off automatic when it is not measuring.

According to the objective of the present invention, an electronic thermometer includes a housing having a display, a power, and a processor, wherein the display and the power are electrically connected to the processor; a sensing member having an end extended out of the housing, wherein the sensing member is electrically connected to the processor; and an automatic switch having two electrodes extended out of the housing and separated from each other, wherein the electrodes are electrically connected to the processor respectively. The automatic switch is normally turned off because the electrodes are not conducted, and the automatic switch is turned on automatic when the electrodes touch water to cause the electrodes conducted.

### BRIEF DESCRIPTION OF THE DRAWINGS

FIG. 1 is a perspective view of a preferred embodiment of the present invention;

FIG. 2 and FIG. 3 are sketch diagrams, showing how the electronic thermometer of the present invention is automatically turned on and turned off; and

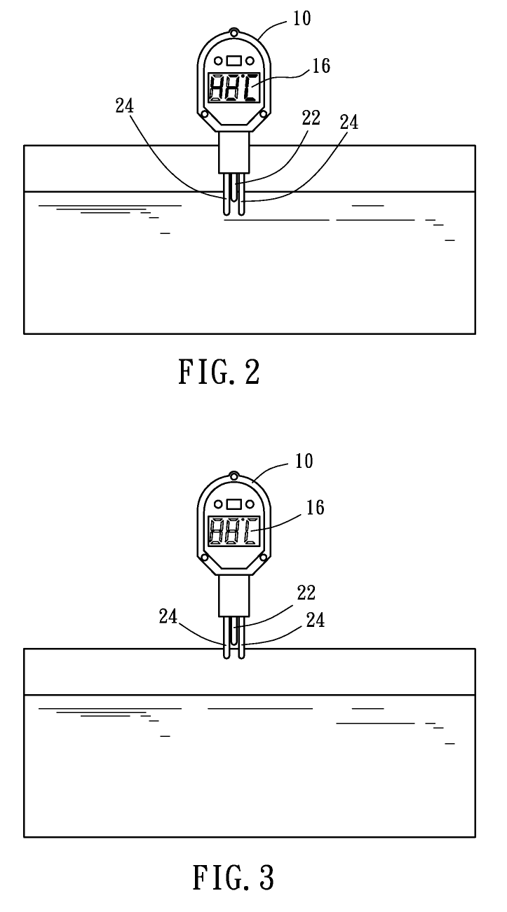

FIG. 4 is a sketch diagram, showing the electronic thermometer of the present invention mounted in a tube.

### DETAILED DESCRIPTION OF THE INVENTION

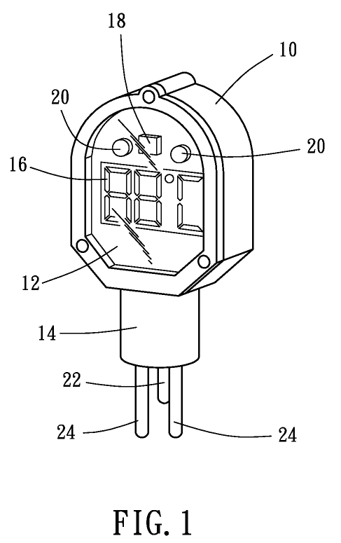

As shown in FIG. 1, an electronic thermometer of the preferred embodiment of the present invention includes:

A housing 10 includes a transparent window 12 on a front side thereof and a post 14 on a bottom thereof. A display 16 is provided in the transparent window 12. The display 16 is a numeral display in the present embodiment showing two numbers and “° C”. In practice, the display 16 may be any type of display, including analog display, digital display, liquid crystal display, and so on. It may show more numbers also, or it may show both Fahrenheit and Celsius scales.

A processor 18, a battery set (not shown), and LED indicators 20 are provided in the housing 10. A sensing member 22 is extended out of the housing 10 via a bottom of the post 14, which transmits temperature data to the processor 18, and then the processor 18 performs some calculations to transform the temperature data and show numerals of the temperature on the display 16.

The main feature of the present invention is that the electronic thermometer of the present invention is provided with an automatic switch, which may turn on the power when it touches water, and turn off when it leaves water. In the present embodiment, the automatic switch includes two electrodes 24 extended out of the bottom of the post 14 of the housing 10 so that there are three parallel members under the post 14, which are the sensing member 22 and the electrodes 24. The electrodes 24 are longer than the sensing member 22. In a normal condition, the electrodes 24 are not conducted that the automatic switch is turned off, and the power is cut off. When the electronic thermometer of the present invention is going to sense temperature, the sensing member 22 will be put in water. In the same time, the electrodes 24 will be conducted through water that automatic switch is turned on, and the power is automatically turned on for sensing temperature. The sensing member 22 transmits the temperature data of water to the processor 18, and the processor 18 performs some calculations to transform the temperature data and show numerals of the temperature on the display 16. After reading the temperature on the display 16, the electronic thermometer of the present invention will be taken out of water. As long as the electrodes 24 leave water, which leave water after the sensing member 22, no medium is between the electrodes 24 to conduct them that the automatic switch is turned off, and the electronic thermometer of the present invention is turned off automatically.

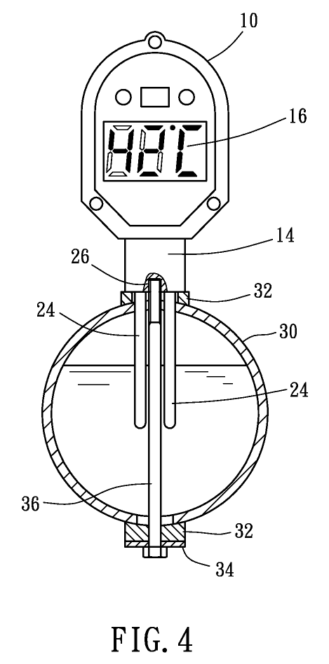

The electronic thermometer of the present invention may be mounted on a pipe or a faucet. FIG. 4 shows the electronic thermometer of the present invention may be mounted on a pipe 30. The pipe 30 is drilled with a transverse hole with two openings on the pipe 30. Two watertight pads 32 are provided on the openings of the pipe 30. The post 14 of the electronic thermometer of the present invention is inserted into the pipe via the upper opening that the sensing member 22 and the electrodes 24 of the automatic switch are received in the pipe 30. A lid 34 seals the lower opening of the pipe with the pad 32. A blot 36 is inserted into the pipe via the lower opening and screwed into a threaded hole on the bottom of the post 14 to secure the electronic thermometer of the present invention on the pipe 30. When water flows through the pipe, the power of the electronic thermometer of the present invention will be turned on automatically because water cause the electrodes 24 conducting, and the power of will be turned off automatically when water in the pipe 30 is cut off.

The description above is a few preferred embodiments of the present invention and the equivalence of the present invention is still in the scope of the claim of the present invention.

What is claimed is:

1. An electronic thermometer, comprising:
a housing having a display, a power, and a processor, wherein said display and said power are electrically connected to said processor;
a sensing member having an end extended out of said housing, wherein said sensing member is electrically connected to said processor; and
an automatic switch having two electrodes extended out of said housing and separated from each other, wherein said electrodes are electrically connected to said processor respectively;
wherein said automatic switch is normally turned off because said electrodes are not conducted, and said automatic switch is turned on automatic when the electrodes touch water to cause said electrodes conducted.

2. The electronic thermometer as defined in claim 1, wherein said electrodes are located beside said sensing member.

3. The electronic thermometer as defined in claim 2, wherein said electrodes are longer than said sensing member.

4. The electronic thermometer as defined in claim 2, wherein said housing has a post, and said sensing member and said electrodes are extended out from said post.

5. The electronic thermometer as defined in claim 2, wherein said housing is provided with a threaded hole within said sensing member and said electrodes.

6. The electronic thermometer as defined in claim 4, wherein said housing has a threaded hole on said post.
